(19) United States
(12) Patent Application Publication
(10) Pub. No.: US 2006/0155440 A1
(43) Pub. Date: Jul. 13, 2006

(54) Roll angle plausibility

(75) Inventor: Jeffrey D. Gleacher, West Bloomfield, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, CA (US)

(21) Appl. No.: 11/327,937

(22) Filed: Jan. 9, 2006

Related U.S. Application Data
(60) Provisional application No. 60/642,725, filed on Jan. 10, 2005.

(51) Int. Cl. B60G 17/016

(52) U.S. Cl. 701/38; 280/735

(57) ABSTRACT

A vehicle safety system (20) includes a controller (24) that predicts a roll angle in response to output signals communicated to the controller (24) from each of a roll rate sensor (26), a lateral accelerometer (30), a vertical accelerometer (32), a longitudinal accelerometer (34), a yaw rate sensor (36) and a pitch rate sensor (38). The controller (24) includes a Kalman Filter to estimate a current vehicle roll angle.

### REFERENCE TO RELATED APPLICATION

This application claims priority to U.S. Provisional Application No. 60/642,725, which was filed on Jan. 10, 2005.

### BACKGROUND OF THE INVENTION

This invention generally relates to vehicle safety systems, and more particularly to a method of determining a vehicle roll angle.

Vehicle safety systems are known that utilize supplemental restraint devices such as air bags that are deployed under selected conditions. A controller onboard the vehicle monitors driving conditions based upon sensor signals and decides when to deploy an airbag.

One type of driving condition monitored by vehicle safety systems is a vehicle rollover. Typically, a roll rate sensor provides a roll rate output signal that is integrated to estimate a roll angle. The safety system controller may make an appropriate determination for deploying a supplemental restraint device in response to the estimated roll angle provided by integration of the roll rate output signal. There are various circumstances under which the processing of a roll rate sensor output signal indicates a vehicle rollover condition even though a vehicle rollover condition does not exist. One example of such an inconsistent indication is caused by an improper integration of the sensor output. Integration of the sensor output may produce significant errors in the calculation of a roll angle because of drift characteristics of the roll rate sensor. Drift characteristics include situations where the angle of the roll rate sensor is different than 0° when the sensor outputs a signal.

Accelerometers may also be utilized to determine a roll angle so that the vehicle safety system may make an appropriate determination for deploying a supplemental restraint device. Accelerometers measure the angle of a vehicle based on the force of gravity acting upon a vehicle in vertical and lateral directions. Disadvantageously, accelerometers are prone to drift which may cause improper calculation of a roll angle and result in an inappropriate deployment of a vehicle restraint device. In addition, dynamic forces experienced when driving, such as those experienced while cornering a sharp turn, may cause errors in the calculated roll angle.

Accordingly, it is desirable to provide a method of estimating a roll angle based on output from a plurality of sensors that accurately represents a rollover condition of the vehicle.

### SUMMARY OF THE INVENTION

An example method of detecting a roll angle of a vehicle comprises determining a roll rate, a vertical acceleration, a lateral acceleration, a longitudinal acceleration, a yaw rate and a pitch rate, estimating a current roll angle, and predicting a future roll angle. In one example, Kalman Filtering is used to estimate the current roll angle.

An example system for detecting a vehicle roll angle includes at least one roll rate sensor, at least one accelerometer, a yaw rate sensor and a pitch rate sensor. A controller determines a future roll angle in response to output signals received by the controller from the roll rate sensor, accelerometer, yaw rate sensor and pitch rate sensor. In one example, the controller includes a Kalman Filter for estimating the roll angle of the vehicle. A vehicle safety system utilizes the predicted roll angle to make an appropriate determination for deploying a supplemental restraint device.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 schematically illustrates selected portions of a vehicle safety system designed according to an embodiment of this invention;

FIG. 2 is a block diagram of a controller for predicting a vehicle roll angle according to the present invention;

FIG. 3 illustrates an algorithm for predicting a vehicle roll angle according to the present invention; and

FIG. 4 is a flow chart illustrating a method of predicting a vehicle roll angle according to the present invention.

### DETAILED DESCRIPTION OF THE PREFERRED EMBODIMENT

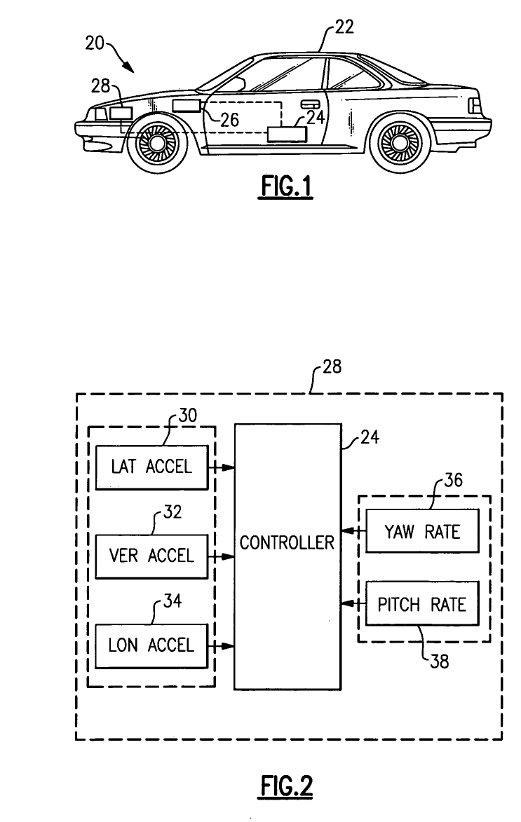

FIG. 1 schematically shows selected portions of a vehicle safety system 20 on board a vehicle 22. A controller 24 processes various sensor signals. In this example, a roll rate sensor 26 provides a roll rate output signal to the controller 24. The example controller 24 determines a vehicle 22 roll angle based on the output signal from the roll rate sensor 26. In one example, the controller 24 integrates the roll rate output signal to determine a roll angle.

A sensor system 28 provides an indication to the controller 24 regarding vehicle dynamics. The roll rate sensor 26 and the sensor system 28 are schematically shown for discussion purposes. Those skilled in the art who have the benefit of this description will realize how many sensor components will best meet the needs of their particular situation and where to locate such components on a particular vehicle in order to predict the roll angle of a particular vehicle 22.

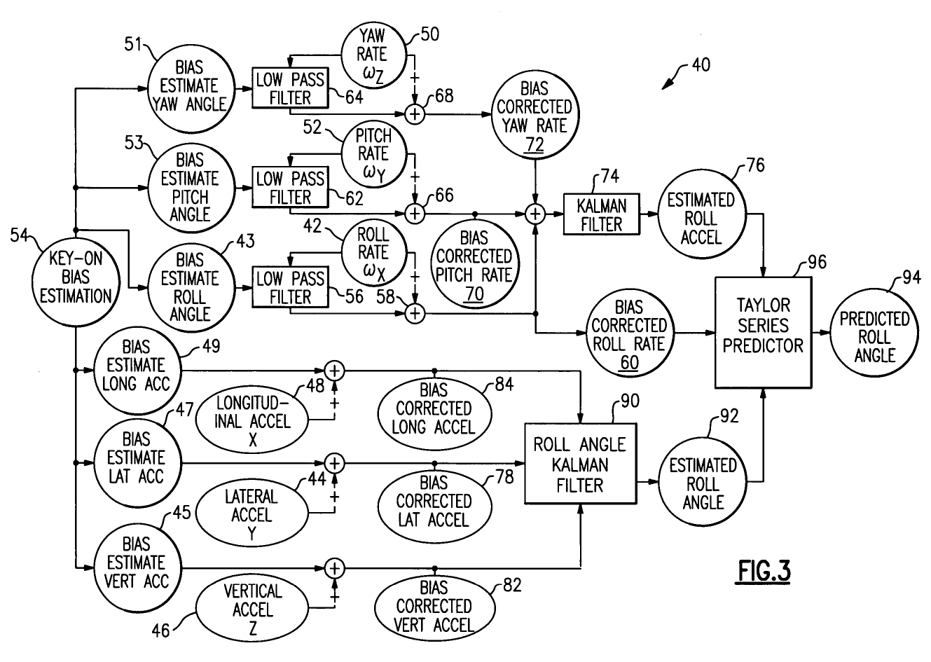

Referring to FIG. 2, the sensor system 28 preferably includes a lateral accelerometer 30, a vertical accelerometer 32, a longitudinal accelerometer 34, a yaw rate sensor 36 and a pitch rate sensor 38. It should be understood that numerous quantities and types of sensors may be utilized with the sensor system 28 of the present invention.

The controller 24 utilizes the information from each sensor to predict a roll angle. The controller 24 communicates the predicted roll angle to the vehicle safety system 20. The vehicle safety system 20 determines whether the predicted roll angle, which is based at least in part on the output from the roll rate sensor 26, is plausible. The vehicle safety system may utilize the controller 24 for making this determination, for example. The controller 24 both predicts the roll angle and controls the vehicle safety system 20 by determining whether the predicted roll angle is plausible. The controller 24 confirms whether a roll angle based on the output signals generated by the roll rate sensor 26 and the sensor system 28 is valid so that the vehicle safety system 20 can then instigate appropriate action by an appropriate portion of the vehicle safety system 20. For example, the vehicle safety system 20 may deploy an airbag in response to the determination that a predicted roll angle is valid.

Referring to FIG. 3, with continuing reference to FIGS. 1 and 2, an algorithm 40 is demonstrated for predicting a roll angle of a vehicle 22. The algorithm 40 is preferably implemented as software in the controller 24 and includes a set of instructions for predicting the roll angle. The controller 24 may be any suitable microcontroller, microprocessor, or computer as is known to one skilled in the art.

The controller 24 selectively and periodically receives a roll rate output signal 42 from the roll rate sensor 26, a lateral acceleration output signal 44 from the lateral accelerometer 30, a vertical acceleration output signal 46 from the vertical accelerometer 32, a longitudinal acceleration output signal 48 from the longitudinal accelerometer 34, a yaw rate output signal 50 from the yaw rate sensor 36 and a pitch rate output signal 52 from the pitch rate sensor 38 in performing the algorithm 40.

The algorithm 40 includes a key-on bias estimation 54 to establish a bias estimate of each of the output signals 42-52. The key-on bias estimation 54 is performed each time the vehicle 22 is started to determine an amount of error in the output signals. Preferably, the key-on bias estimation 54 occurs for at least three seconds following start-up of the vehicle 22 to determine a bias estimate of the roll rate 43, a bias estimate of the vertical acceleration 45, a bias estimate of the lateral acceleration 47, a bias estimate of the longitudinal acceleration 49, a bias estimate of the yaw rate 51 and a bias estimate of the pitch rate 53. The key-on bias estimation 54 averages the signals from each of the output signals 42-52 over the first few seconds following start-up of the vehicle 22 and determines the amount of bias in each of the corresponding output signals.

The bias estimate of the roll rate 43 and the roll rate output signal 42 are input into a low pass filter 56. The low pass filter 56 produces an average value roll rate output over a designated period of time. Preferably, the average value roll rate output is produced over a period of at least two minutes. The average value roll rate output is then input into a summing node 58. The summing node 58 subtracts the average value roll rate output from the roll rate output signal 42 to produce a bias corrected roll rate 60.

The bias estimate of the pitch rate 53 and the yaw rate 51 are also input into a low pass filter 62, 64 respectively. The low pass filters 62, 64 perform in an identical manner to the low pass filter 56. The output from each of the low pass filters 62, 64 is input into a summing node 66, 68 to establish a bias corrected pitch rate 70 and a bias corrected yaw rate 72.

The bias corrected roll rate 60, the bias corrected pitch rate 70 and the bias corrected yaw rate 72 are each input into a first Kalman Filter 74. The first Kalman Filter 74 generates an estimated roll acceleration 76.

Kalman Filters incorporate data and knowledge of various system dynamics to generate an overall best estimate of a current value of a variable of interest (i.e. roll acceleration). Kalman Filters recursively estimate the dynamic state of a vehicle based upon certain input values. In other words, the Kalman Filter incorporates discrete-time measurements, rather than continuous time inputs, and utilizes a data processing algorithm to filter out noise in the measurements to estimate the current variable of interest.

A bias corrected lateral acceleration 78 is produced by inputting the lateral acceleration output signal 44 and the bias estimate of the lateral acceleration into a summing node 80. The bias corrected lateral acceleration 78 is calculated by subtracting the bias estimate of the lateral acceleration 47 from the lateral acceleration output signal 44. A bias corrected vertical acceleration 82 and a bias corrected longitudinal acceleration 84 are produced in an identical manner by utilizing summing nodes 86 and 88.

The bias corrected roll rate 60, the bias corrected lateral acceleration 78, the bias corrected vertical acceleration 82 and the biased corrected longitudinal acceleration 84 are each input into a second Kalman Filter 90. The second Kalman Filter 90 estimates the current roll angle 92 of the vehicle 22 as a function of the bias corrected roll rate 60, the bias corrected lateral acceleration 78, the bias corrected vertical acceleration 82 and the bias corrected longitudinal acceleration 84. As is known, the first and second Kalman Filters 74, 90 filter out white noise, or uncertainties in the quantities being modeled, that are included in the input values utilized to estimate the roll acceleration 76 and the current roll angle 92.

The physical model of the second Kalman Filter 90 may be represented by the following equations:
∫ωₓdt=θₓ, where θₓ is the roll angle [1]
∫ω_{y}dt=θ_{y}, where θ_{y} is the pitch angle [2]
∫ω_{z}dt=θ_{z}, where θ_{z} is the yaw angle [3]
y=−sin(θx) [4]
x=sin(θy) [5]
z=1−cos(√(θₓ²+θ_{y}²)) [6]
wherein:
θₓ is the roll angle, and ωₓ is the roll rate;
θ_{y} is the pitch angle, and ω_{y} is the pitch rate;
θ_{z} is the yaw angle, ω_{z} is the yaw rate; and
y is lateral acceleration, x is longitudinal acceleration and z is vertical acceleration.

A Taylor series predictor 96 generates a predicted roll angle 94. The predicted roll angle 94 is generated as a function of the estimated roll acceleration 76, the bias corrected roll rate 60 and the current roll angle 92. The Taylor series predictor 96 predicts the predicted roll angle 94 by selecting an advance time for making a prediction.

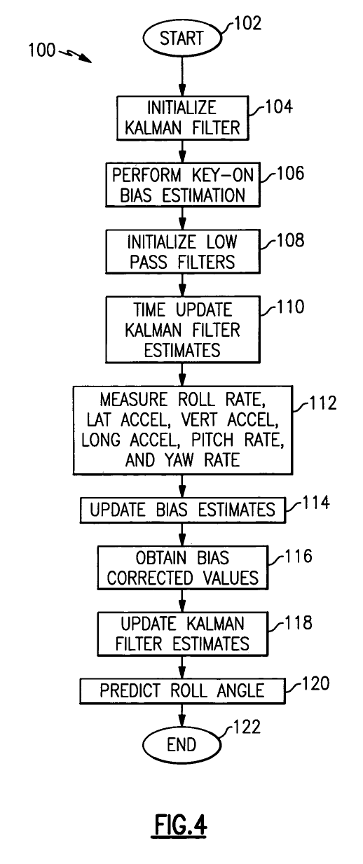

Referring to FIG. 4, and with continuing reference to FIGS. 1, 2 and 3, a method 100 of predicting a vehicle roll angle is demonstrated. The method 100 begins at start block 102 where power is applied to the system and proceeds to initialize first and second Kalman Filters 74, 90 at step block 104. The initialization includes initializing all variables to either zero or other appropriate values based on available prior information, including a known value of the vehicle 22 roll angle. Next, at step block 106, key-on bias estimation is performed. Subsequent to turning on the ignition of the vehicle 22, the roll rate sensor 26, the vertical accelerometer 32, the lateral accelerometer 30, the longitudinal accelerometer 34, the yaw rate sensor 36 and the pitch rate sensor 38 are permitted to warm up and stabilize for a period of time. After a period of time, for example two seconds, the output signals from each sensor are averaged to obtain a zero offset bias level.

The low pass filters 56, 62 and 64 are initialized at block step 108 to estimate the roll rate output signal 42, the yaw rate output signal 50 and the pitch rate output signal 52 over a period of time. For example, the average value of the output signals may be obtained over a period of two minutes. The average values are taken to be the bias levels of the roll rate sensor 26, the pitch rate sensor 38 and the yaw rate sensor 36. Each of the sensors are initialized to the key-on bias estimation value obtained at step block 106.

At step block 110, the second Kalman Filter 90 produces time updated estimates of its output signals. The time update uses the dynamic model of the process involving the calculations being estimated. The time update modifies the estimates produced by the second Kalman Filter 90 to account for time which has elapsed since the prior estimates were made.

At step block 112, a roll rate output signal 42, a lateral acceleration output signal 44, a vertical acceleration output signal 46, a longitudinal acceleration output signal 48, a pitch rate output signal 52 and a yaw rate output signal 50 from each of the respective sensors 26-38 are measured by the controller 24. Next, at step block 114, the bias estimate values for the roll rate, the vertical acceleration, the lateral acceleration, the longitudinal acceleration, the yaw rate and the pitch rate are updated.

At step block 116, the bias corrected roll rate 60, the bias corrected lateral acceleration 78, the bias corrected vertical acceleration 82 and the biased corrected longitudinal acceleration 84 are obtained by subtracting the corresponding bias estimates from the measured values of roll rate, lateral acceleration, vertical acceleration, and longitudinal acceleration. The estimates from block 110 contained in the second Kalman Filter 90 are updated at step block 118 using the bias-corrected values obtained at step block 116. This update alters the estimates to account for differences between the current measurements and their predicted values based on the current estimates.

At step block 120, a predicted roll angle is produced by obtaining a weighted sum of the estimated roll angle, the bias estimated roll rate and the roll acceleration. The predicted roll angle is then communicated to a vehicle safety system 20 for analysis with other factors to determine the necessity of deployment of a vehicle restraint device such as an airbag. Pursuant to stop block 122, the method 100 is complete.

The foregoing description shall be interpreted as illustrative and not in a limiting sense. A worker of ordinary skill in the art would recognize that certain modifications would come within the scope of this invention. For that reason, the following claims should be studied to determine the true scope and content of this invention.

We claim:

1. A method of detecting a vehicle roll angle, comprising:
(a) receiveing output signals indicative of a roll rate, a vertical acceleration, a lateral acceleration, a longitudinal acceleration, a yaw rate and a pitch rate of a vehicle;
(b) estimating a current roll angle; and
(c) predicting a future roll angle in response to the estimate of the current roll angle and the output signals communicated from said step (a).

2. The method as recited in claim 1, further comprising the step of:
determining a bias estimate of the output signals and subtracting the bias estimate from the output signals.

3. The method as recited in claim 1, wherein said step (b) comprises:
performing Kalman Filtering.

4. The method as recited in claim 1, wherein said step (c) comprises:
selecting an advance time for predicting the future roll angle.

5. A method of detecting a vehicle roll angle, comprising:
(a) determining a roll rate, a vertical acceleration, a lateral acceleration, a longitudinal acceleration, a yaw rate and a pitch rate;
(b) determining a bias estimate of the roll rate, a bias estimate of the vertical acceleration, a bias estimate of the lateral acceleration, a bias estimate of the longitudinal acceleration, a bias estimate of the yaw rate and a bias estimate of the pitch rate;
(c) determining a bias corrected roll rate in response to the roll rate and the bias estimate of the roll rate;
(d) determining a roll acceleration;
(e) estimating a current roll angle in response to the bias corrected roll rate, a bias corrected vertical acceleration, a bias corrected lateral acceleration and a bias corrected longitudinal acceleration; and
(f) predicting a roll angle in response to the bias corrected roll rate, the roll acceleration and the estimated current roll angle.

6. The method as recited in claim 5, wherein said step (b) comprises:
averaging the roll rate, the vertical acceleration, the lateral acceleration, the longitudinal acceleration, the yaw rate and the pitch rate for a predefined amount of time in response to start up of a vehicle.

7. The method as recited in claim 6, wherein said predefined amount of time is at least 3 seconds.

8. The method as recited in claim 5, wherein said step (c) comprises:
averaging the bias estimate of the roll rate and the roll rate for a predefined amount of time to produce an average value output and subtracting the average value output from the roll rate.

9. The method as recited in claim 8, wherein said predefined amount of time is two minutes.

10. The method as recited in claim 5, wherein said step (d) comprises:
performing Kalman filtering.

11. The method as recited in claim 5, wherein said step (d) comprises:
determining the roll acceleration in response to the bias corrected roll rate, a bias corrected yaw rate and a bias corrected pitch rate, wherein the bias corrected yaw rate is calculated by subtracting the bias estimate of the yaw rate from the yaw rate and the bias corrected pitch rate is calculated by subtracting the bias estimate of the pitch rate from the pitch rate.

12. The method as recited in claim 5, wherein said step (e) comprises:
determining the bias corrected vertical acceleration by subtracting the bias estimate of the vertical acceleration from the vertical acceleration, determining the bias corrected lateral acceleration by subtracting the bias estimate of the lateral acceleration from the lateral acceleration, and determining the bias corrected longitudinal acceleration by subtracting the bias estimate of the longitudinal acceleration from the longitudinal acceleration.

13. The method as recited in claim 5, wherein said step (e) comprises:
performing Kalman filtering.

14. The method as recited in claim 5, wherein said step (f) comprises:
selecting an advance time for predicting the roll angle.

15. The method as recited in claim 5, further comprising the step of:
(g) communicating the roll angle as an output signal to a vehicle safety system.

16. A system for detecting a vehicle roll angle, comprising:
at least one roll rate sensor;
at least one accelerometer;
a yaw rate sensor and a pitch rate sensor; and
a controller that predicts a future roll angle in response to signals communicated to said controller from each of said roll rate sensor, said at least one accelerometer, said yaw rate sensor and said pitch rate sensor, wherein said controller includes a Kalman Filter that estimates a current roll angle.

17. The system as recited in claim 16, wherein said at least one accelerometer comprises a vertical accelerometer, a lateral accelerometer and a longitudinal accelerometer.

18. The system as recited in claim 16, further comprising a bias estimator for estimating bias in each of said signals.

19. The system as recited in claim 16, wherein said controller estimates a current roll angle and predicts said future roll angle in response to said current roll angle.

20. The system as recited in claim 16, wherein said controller communicates said future roll angle as an output signal to a vehicle safety system.
